(19) United States
(12) Patent Application Publication
(10) Pub. No.: US 2025/0276498 A1
(43) Pub. Date: Sep. 4, 2025

(54) METHOD FOR MODELLING A COMPOSITE PART

(71) Applicant: Airbus Operations GmbH, HAMBURG (DE)

(72) Inventors: Henrik ESCHEN, HAMBURG (DE); Lennart FINGER, HAMBURG (DE); Jan BOYKSEN, HAMBURG (DE); Pezhman POURABDOLLAH, HAMBURG (DE); Raphael HÖFER, HAMBURG (DE); Tim FRERICH, HAMBURG (DE)

(21) Appl. No.: 19/065,155

(22) Filed: Feb. 27, 2025

(30) Foreign Application Priority Data
Feb. 29, 2024 (EP) 24160698.7

(51) Int. Cl. B29C 70/54; B29C 70/20; G06F 30/15; G06F 30/23

(52) U.S. Cl. CPC B29C 70/54; B29C 70/202; G06F 30/15; G06F 30/23

(57) ABSTRACT

A method for modelling a composite part, comprising the steps: preparing a model of the composite part having at least one ply with a single or multiple curved in-plane fiber orientation; and modifying the model iteratively, thereby modifying the fiber orientation until a weight reduction of the model is achieved compared to a preceding model maintaining predetermined mechanical properties of the composite part. Also a composite part.

### CROSS-REFERENCES TO RELATED APPLICATIONS

This application claims the benefit of European Patent Application Number 24160698.7 filed on Feb. 29, 2024, the entire disclosure of which is incorporated herein by way of reference.

### FIELD OF THE INVENTION

The present invention refers to a method for modelling a composite part made from composite material, and a composite part.

### BACKGROUND OF THE INVENTION

This invention relates to the field of composite materials made either from CFRP-tape with a thermoplastic or thermoset matrix or from dry fiber material. It furthermore relates to the ply or tow deposition of said composite material. In different industries, preferred ply layups haven been established. For instance, aircraft parts, which are rather strictly due to safety requirements, are made from a similar ply layup composing of 0°,90°,45° and −45° plies. These are laid up manually, by ATL or AFP, at least for aircraft components. By adjusting the ratio and stacking between these plies, the part behavior can be tailored to a specific load case. This approach is however limited by the unidirectionality of those plies, as they are always oriented in the same direction. Such known composite part 1 is illustrated in FIGS. 1 and 2. The known composite part 1 is made from a ply stack 2 comprising four plies 4, 6, 8, 10. Each ply has a different monoaxial fiber orientation and a defined thickness. Here, the first ply is a 0° ply 4, the second one is a 90° ply 6, the third one is a 45° ply 8 and the third one is a −45° ply 10.

What could be considered prior art is the topology optimization approaches of state of the art finite-element tools such as HyperWorks. One approach for defining stiffness variation in structures is the discrete fiber angle representation. This method extends the concept of a multi-patch laminate to define laminates locally at each point in the structure. Consequently, specific points within the discretized structure have defined fiber angles and stacking sequences. Typically, this discretization aligns with the underlying structural analysis method, like the finite element method (FEM). With this approach, ensuring fiber continuity is not guaranteed. The end result is usually some sort of vector field with each element having a specific optimum fiber orientation, however these do not always match up with the adjacent elements, so no coherent “path” can be found to lead through all the elements directions.

### SUMMARY OF THE INVENTION

It is an object of the present invention to provide a method for modelling a composite part and an optimized composite part.

The object may be achieved by a method and/or by a composite part as described according to one or more embodiments herein.

According to the invention, an inventive method for modelling a composite part, comprises the following steps:
Preparing a model of the composite part having at least one ply with a single or multiple curved in-plane fiber orientation; and
Modifying the model iteratively, thereby modifying the fiber orientation until a weight reduction of the model is achieved compared to a preceding model maintaining predetermined mechanical properties of the composite part.

The inventive method relates to the possibility of using variable angle tow (VAT) orientations within a ply. For example, a steering/bent tow from an AFP machine may be able to transfer the loads more directly and in a way that is suitable for the part. In particular the invention relates to a method to determine how such a tow is supposed to be oriented while incorporating a structural analysis to achieve the best possible result. The method according to the invention enable the optimization of fiber angles, thereby unlocking the ability to attain desired stiffness and strength properties effectively. At least one variable tow angle ply/layer is generated to achieve a further optimized design tailored to each specific load case. This result in a lower weight compared to quasi-isotropic layups, to a certain desired bending shape, thereby keeping desired strength properties. The invention entails an all-encompassing process chain, commencing with composite design which can culminate in the production of the final manufactured part. Optimization algorithms can be used to find the optimal distribution of fiber angles in a laminate to achieve desired stiffness and strength properties. Physics-based analyses, such as finite element analysis (FEM), can be used to evaluate the performance of the design and provide feedback to the optimization algorithm. Instead of path planning, which is based on a large number of vectors between which common manufacturable paths must be found, the inventive master spline concept works in reverse. At least one fiber path is first proposed and applied to the mechanical problem. The performance of this path design is then evaluated.

The model can be made from a ply stack, comprising the ply with the single or multiple curved in-plane fiber orientation; and at least a further ply having a different fiber orientation. By modelling a ply stack, the composite part can be adjusted optimally to different mechanical properties.

The weight can further be reduced by modifying a thickness of at least one ply. Preferably, the thickness of each ply is modified. By means of this, every ply is taken into account during weight optimization.

In order to ensure that the ply with the single or multiple curved in-plane fiber orientation remains a part of the composite part, a minimum thickness of the ply is kept larger than zero.

Preferably, load cases are applied to the model during the optimization procedure. By means of this, the entire ply stack is considered and not only some of the plies.

The manufacturing of the ply with single or multiple curved in-plane fiber orientation can be simplified by reproducing s single or multiple curved in-plane fiber path over the entire ply.

Preferably, manufacturing constraints are taken into account when modifying the single or multiple curved in-plane fiber orientation. By means of this, the manufacturing is further simplified as it is guaranteed that the optimized ply stack can be manufactured practically. This approach avoids the cumbersome determination of fiber paths according to theoretical “ideal” vector fields and moves closer to a design for manufacturing approach by generating fibers fitting with production boundary conditions (steering radii, etc.). In particular, if the optimization starts from manufacturable paths and adjusts them to fit as well as possible with the load case this problem is mitigated. It may not be the most mathematically perfect result, but it ensures manufacturability and can be considered the best possible result under specific manufacturing constraints.

The model can be used as manufacturing data for a manufacturing machine adapted to manufacture the composite part. By means of this, the generated ply stack can be used directly for manufacturing. Any problem due to date mitigation does not occur.

A preferred composite part is manufactured via the inventive method. Such a composite part has reduced weight compared to traditional generated ply stacks, thereby keeping the mechanical strength.

### BRIEF DESCRIPTION OF THE DRAWINGS

In what follows, a preferred embodiment of the present invention is explained with respect to the accompanying drawings. As is to be understood, the various elements and components are depicted as examples only, may be facultative and/or combined in a manner different than that depicted. Reference signs for related elements are used comprehensively and not necessarily defined again for each figure. Shown is schematically in

FIG. 1 is a composite part having a ply stack according to the prior art;

FIG. 2 shows the ply stack of the known composite part shown in FIG. 1;

FIG. 3 is an exemplary composite part having a ply stack according to the present invention;

FIG. 4 shows the ply stack of the inventive composite part shown in FIG. 3.

### DETAILED DESCRIPTION OF THE PREFERRED EMBODIMENTS

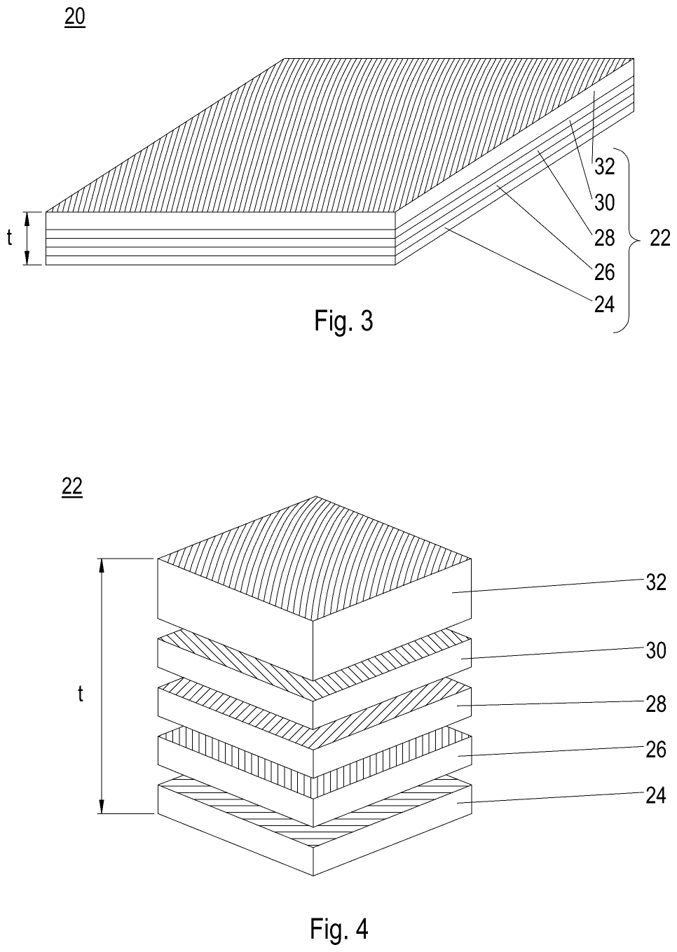

In FIG. 3, an inventive composite part is shown.

The composite part can be made either from CFRP-tape with a thermoplastic or thermoset matrix or from dry fiber material. The composite part 20 is made from a ply stack 22 as shown in FIG. 4. The ply stack 22 comprising several plies 24, 26, 28, 30 with monoaxial fiber orientations and at least one ply 32 having a single or multiple curved in-plane fiber orientation. In the following, the ply 32 having a single or multiple curved in-plane fiber orientation is called variable ply 32. Here the variable ply 32 has a single curved in-plane fiber orientation.

The plies are laid up manually or, preferably automatically by automated tape laying (ATL) or by automated fiber placement (AFP).

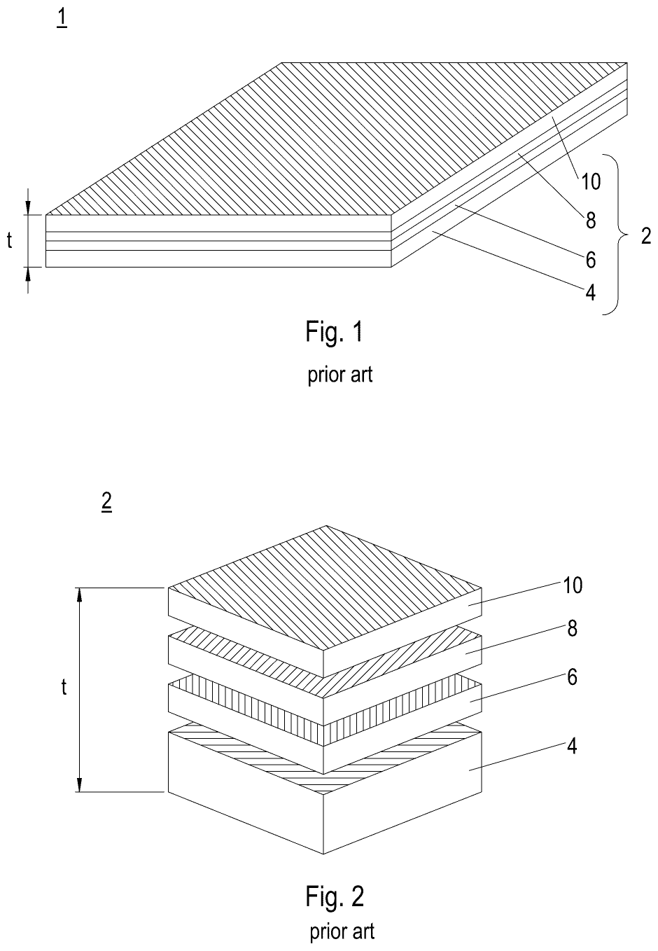

The composite part 20 has the same shape, function and mechanical properties as the known composite part 20 shown in FIGS. 1 and 2. Both composite parts 1, 20 have the same thickness t (height), but different weights and different number of plies 4, 6, 8, 10 and 24, 26, 28, 30, 32. Although the inventive composite part 20 comprises one more ply 32, i.e. the variable ply 32, than the known composite part 1, the inventive composite part 20 has a reduced weight compared to the known composite part 1 having one ply 4, 6, 8, 10 less.

For the sake of illustration, here the inventive composite part 20 comprises the same initial ply stack 2 as the known composite part 1. This means, the first ply 24 is a 0° ply, the second one 26 is a 90° ply, the third one 28 is a 45° ply and the fourth one 30 is a −45° ply. In addition, the variable ply 32 is add to the initial ply stack 2.

Due to this, the thickness of each monoaxial ply 24, 26, 28, 30 can vary compared to the respective ply 2, 4, 6, 8 of the known composite part 1. However, the overall thickness t of the inventive composite part 20 is not larger than the thickness t of the known composite part 1. The optimal thickness of each ply 24, 26, 28, 30, 32 and an optimal curved in-plane fiber orientation is achieved iteratively by applying load cased to the (joined) ply stack 22. Thereby, the modelling of the ply stack 22 is stopped, when a weight reduction is reached, whereby predetermined mechanical properties are maintained.

The inventive method to model such ply stack 22 is based on an iterative, self-contained cycle. The self-contained cycle aims to generate and optimize feasible fiber path orientations. On one side, fiber paths are geometrically defined inside the input CAD data of the composite part to be developed. Parallel to the design of the composite part, a mesh is generated for FE-Analysis and optimization. Within this, path generation is linked to current FEM programs and paths are automatically parsed and evaluated.

After the optimization goal has been reached, the mechanically most sensible paths can then be used for the further development process. A variable-axial position can now be created for a mechanical problem defined in a finite element file. Here, a variable angle tow ply (ply having a single or multiple in-plane curved fiber orientation), which can be locally optimized in its tow angle is introduced. The definition of the FEM file then also allows further sub-optimizations. Complex optimizations regarding a topology, layer thicknesses, shape could also be stored in this file. This means that further parameters can be introduced into the overall optimization function.

In other words, a method for modelling a composite part, comprising the steps:
Preparing a model of the composite part 20 having at least one variable ply 32; and
Modifying the model iteratively, thereby modifying the fiber orientation of the variable ply 32 until a weight reduction of the model is achieved compared to a preceding model maintaining predetermined mechanical properties of the composite part 20.

It should be noted that the composite part 20 can be made only from the variable ply 32. Alternatively, the composite part 20 can be made from a ply stack 22 comprising the variable ply 32 and at least a further ply 24, 26, 28, 30 having a different fiber orientation as shown in FIGS. 3 and 4.

During modelling, load cases are applied to the single ply 32 or to the ply stack 22, thereby the thicknesses of each ply 24, 26, 28, 30, 32 and the curved fiber orientation is adjusted. In order to avoid that the variable ply 32 is cancelled during modelling, its minimum thickness is set larger than zero.

If the optimization goal is reached, if in particular a weight reduction of the modelled composite part 20 has been reached thereby maintaining predetermined mechanical properties, the model data are used as manufacturing data for a manufacturing machine, for instance an AFP machine (or ATL machine), such that the composite part 20 can be manufactured directly. In order to make sure that the manufacturing machine is able to manufacture the single or multiple curved in-plane fiber orientation, manufacturing constraints of the manufacturing machine are taken into account directly at the beginning when the curved in-plane fiber orientation is defined initially. In a preferred embodiment, the curved fiber orientation is defined by s single fiber path which is reproduced over the entire ply.

Disclosed are a method for modelling a composite part, comprising the steps: preparing a model of the composite part having at least one ply with a single or multiple curved in-plane fiber orientation; and modifying the model iteratively, thereby modifying the fiber orientation until a weight reduction of the model is achieved compared to a preceding model maintaining predetermined mechanical properties of the composite part, and a composite part.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### Reference Signs

### Prior art

1 composite part
2 ply stack
4 first ply
6 second ply
8 third ply
10 fourth ply

### Invention

20 composite part
22 ply stack
24 first ply
26 second ply
28 third ply
30 fourth ply
32 fifth ply
t thickness (height)

1. A method for modelling a composite part, comprising the steps of:
preparing a model of a composite part having at least one ply with a single or multiple curved in-plane fiber orientation; and
modifying the model iteratively, thereby modifying the single or multiple curved in-plane fiber orientation until a weight reduction of the model is achieved compared to a preceding model maintaining predetermined mechanical properties of the composite part.

2. The method according to claim 1, wherein the model is made by modelling a ply stack, comprising:
the at least ply with the single or multiple curved in-plane fiber orientation; and
at least a further ply having a different fiber orientation.

3. The method according to claim 1, wherein a thickness of the at least one ply is modified.

4. The method according to claim 1, wherein a minimum thickness of the at least one ply with the single or multiple curved in-plane fiber orientation is kept larger than zero.

5. The method according to claim 1, wherein load cases are applied to the model.

6. The method according to claim 1, wherein the single or multiple curved in-plane fiber orientation is defined by a single fiber path which is reproduced over an entirety of the at least one ply.

7. The method according to claim 1, wherein manufacturing constraints are taken into account when modifying the single or multiple curved in-plane fiber orientation.

8. The method according to claim 1, wherein the model is used as manufacturing data for a manufacturing machine configured to manufacture the composite part.

9. The method according to claim 1, further comprising:
manufacturing a composite part from the model with the weight reduction.

10. A composite part manufactured via the method according to claim 1.
